(19) United States
(12) Patent Application Publication
(10) Pub. No.: US 2019/0052296 A1
(43) Pub. Date: Feb. 14, 2019

(54) Method for Transmitting a Value Measured by a Sensor, Method for Receiving the Measured Value, Sensor, Control Device

(71) Applicant: Robert Bosch GmbH, Stuttgart (DE)

(72) Inventors: Marlon Ramon Ewert, Untergruppenbach (DE); Guenter Weiss, Walheim (DE)

(21) Appl. No.: 16/073,239

(22) PCT Filed: Dec. 22, 2016
(86) PCT No.: PCT/EP2016/082366

§ 371 Date: Oct. 31, 2018

(30) Foreign Application Priority Data
Jan. 29, 2016 (DE) 10 2016 201 411.0

(51) Int. Cl. H04B 1/3822; H04B 17/00; B60R 21/01

(52) U.S. Cl. CPC H04B 1/3822; B60R 2021/01068; B60R 21/01; H04B 17/0085

(57) ABSTRACT

A method for transmitting a value measured by a sensor. The measured value is copied onto a data word by a function in order to be transmitted.

The present invention relates to a method for transmitting a measured value by a sensor, a corresponding method for receiving the measured value, and a sensor and a control device as claimed in the independent claims.

### PRIOR ART

A method for digital data transmission from a sensor to a control device is known from DE 101 49 332 A1, in which the sensor values of the sensor are divided with different resolutions for the data transmission. The sensor values form a first range of values with sequential sensor values. The division of the first range of values for the data transmission is made depending on a value relevant for the control device.

PSI5 is an open standard, and supports the querying of up to four sensors per bus node, which can be queried in different configurations. A bidirectional communication for sensor configuration and diagnosis is also provided.

In airbag systems, data from, for example, pressure or acceleration sensors are evaluated over current-modulated two-wire buses which communicate with the control device using a Manchester-encoded protocol.

The possible operating modes are also specified in the standard. These are initially differentiated into synchronous and asynchronous operating modes. In the synchronous operating modes, these three operating modes emerge, depending on the interconnection of the sensors with the control unit: parallel bus mode (all sensors are connected in parallel), universal bus mode (serial interconnection of the sensors) and daisy chain bus mode. Combined with other parameters such as the total number of timeslots, data rate, data word length, parity/CRC monitoring, the PSI5 standard allows for various possible realizations. The use of the 10-bit data word length is widespread.

As a rule, PSI5 sensors used nowadays use a resolution with a fixed definition for the measured value of a sensor channel on a single communication slot. This resolution, with its fixed definition, is usually constant over the entire acquisition range of the sensor.

A disadvantage of the practice to date is the compromise that is necessary between a high measured value resolution and a wide measuring range. A 10-bit sensor today, for example, either supports a high resolution with a low measuring range or a wide measuring range with low resolution. This is above all counter-productive when one and the same sensor is used for different applications, wherein the measuring ranges and resolutions for the different applications fundamentally differ and are thus not compatible with one another. This can above all have a negative effect on the configuration of algorithms (such as, for example, algorithms for triggering restraining means in airbag control devices).

### DISCLOSURE OF THE INVENTION

Against this background, a method for transmitting a measured value of a sensor is proposed with the present invention, in which the measured value is mapped onto a data word by means of a function in order to be transmitted.

In the context of the present invention, the function represents a mathematical function with the aid of which straight lines, curves or functions that describe the mapping of the measured values of the sensor onto a data word are encoded.

The mapping then takes place optionally in software on the sensor or through a logic within the sensor ASIC. A transmission of the data word calculated from the measured value then takes place over, for example, a communication bus.

According to an advantageous variant, the mapping takes place in such a way that predetermined value ranges are mapped with a higher resolution.

This variant entails the advantage that critical value ranges in particular are transmitted with a higher resolution. Which value ranges are critical depends heavily here on the particular sensor type, the location where the sensor is fitted, and on the application that processes the sensor signals.

In an application for triggering retention means, such as for example airbags, critical ranges are located near to the trigger thresholds.

A variant of the method for transmitting measured values according to the present invention, in which the function is a non-linear and/or non-symmetric and/or non-continuous function is of particular significance.

A non-linear function here refers to a function that maps a range of measured values onto a value range with a resolution that has different resolutions.

A non-symmetric function refers in the present case to a function that maps the range of measured values onto a value range of the data word that is not structured symmetrically about the zero point.

The use of a suitable, arbitrary function for mapping the measured value onto the transmitted data word has the advantage that, depending on the application that processes the received measured value, particular measured value ranges are emphasized, i.e. can be transmitted with a higher resolution. Other measured value ranges, on the other hand, that are not to be emphasized, can be transmitted with a lower resolution. In an extreme manifestation, these measured value ranges are not even transmitted at all.

A further aspect of the present invention is a sensor that is designed in such a way that the sensor carries out all steps of a variant of the method for transmitting a measured value according to the present mapping.

In an advantageous form of embodiment of the sensor, at least one function for mapping measured values onto data words is stored in the sensor.

The sensor can have appropriate storage means for this purpose.

In an advantageous form of embodiment of the receiver, at least one function for mapping data words onto measured values is stored in the receiver.

According to a particular variant of this form of embodiment, in an initialization phase, the sensor transmits the function of the at least one stored function selected for the mapping.

According to this variant, the use of the sensor of the present invention is significantly simplified.

Depending on the type of application, wherein the type of application refers to the type of sensor (pressure or inertial sensor), the place of use (upfront sensor, side impact sensor, . . . ), the application type (crash detection, crash plausibility checking, pedestrian impact detection), a corresponding stored function can be selected, which is transmitted during the initialization. Instead of the function itself, or of its mathematical representation, it is also conceivable that a value is transmitted that uniquely identifies the selected function for the receiver.

A further aspect of the present invention is a method for the manufacture of a sensor according to the present invention, in which the at least one function is stored in the sensor during manufacture.

It is advantageous with this method of manufacture, that the sensor is ready for use immediately after manufacture, without the need for a configuration or adjustment of the sensor to be carried out prior to application or installation.

In this manufacturing method all the relevant functions for the mapping are stored in the sensor during the manufacturing.

It would also be conceivable for the stored functions to be appropriately protected, for example to be stored in signed form in the sensor, so that a subsequent manipulation or modification is not possible, or at least that it does not remain undetected.

A further aspect of the present invention is a method for receiving a measured value in which the measured value is determined by means of a function from a received data word.

According to this method, the measured value mapped onto the data word is again back-calculated in the receiver onto the value space of the application that is using it in the receiver. The function in the receiver is obviously directly related to the function in the sensor with which the measured value is mapped onto the data word to be transmitted.

According to an advantageous variant of the method for receiving the measured value according to the present invention, in an initialization phase a function is received, wherein the function for determining depends on the received function.

The advantage of this variant is that first, in an initialization phase, the function with which the measured values are mapped onto the data words to be received is received by the receiver. Depending on this received function, the appropriate function with which the measured value is determined from the data words to be received can be specified in the receiver.

It is clear that instead of the function itself, or of its mathematical representation, a value can also be transmitted that uniquely identifies the selected function for the receiver.

Forms of embodiment of the present invention are represented with reference to figures and explained below. Here:

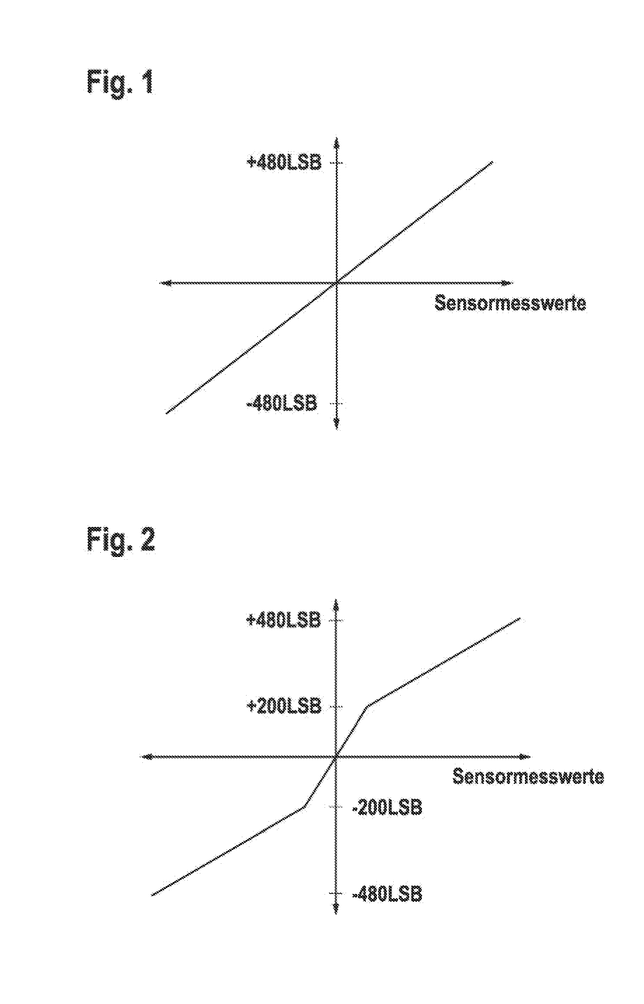

FIG. 1 shows a linear mapping of measured sensor values onto sensor signals of a communication bus according to today's prior art;

FIG. 2 shows a mapping of measured sensor values onto data words for transmission according to the present invention;

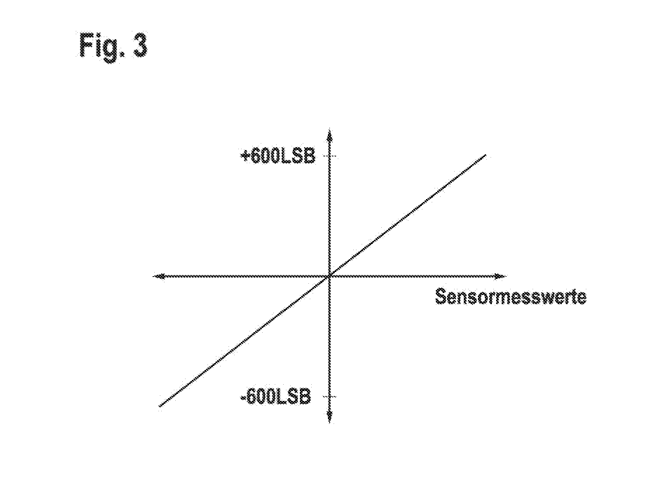

FIG. 3 shows a mapping of sensor signals onto measured sensor values after reception according to the present invention;

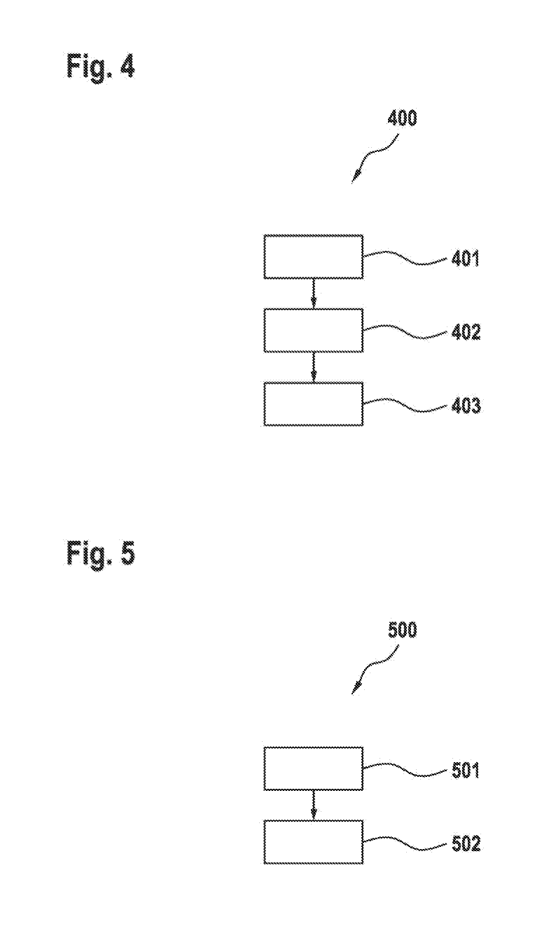

FIG. 4 shows a flow diagram of a form of embodiment of a method for transmitting a measured value according to the present invention;

FIG. 5 shows a flow diagram of a form of embodiment of a method for receiving a measured value according to the present invention.

FIG. 1 shows a linear mapping of measured sensor values onto data words for transmission of the measured sensor values of a communication slot, for example on a communication slot according to the PSI5 protocol, or on a point-to-point connection according to the prior art. The data range of a 10-bit sensor for a sensor channel according to FIG. 1 is here formed linearly from the measured sensor values from −480 LSB up to +480 LSB.

The measured sensor values are plotted on the abscissa. The values of the data word are plotted on the ordinate. The red line here represents the linear assignment of the range of measured sensor values to the data word range of +/−480 LSB.

FIG. 2 shows a mapping of measured sensor values onto data words for transmission according to the present invention. As shown in FIG. 2, the measured sensor values of the sensor are initially mapped up to a range of +/−200 LSB with a high resolution onto the sensor signals of the communication bus. This can be recognized through the steep, straight section between the measured sensor values that are mapped onto the data word range from +/−200 LSB. The measured sensor values between +/−200 LSB and +/−480 LSB are then transferred with a lower resolution onto the data words for transmission on the communication bus. This is illustrated through the straight sections with lower gradients.

The illustration in FIG. 2 is only to be looked on as an example. The converse case is, of course, also conceivable, as is the mapping by means of curves or functions.

According to the present invention, the straight lines, curves or functions in the sensor are encoded by means of mathematical functions or approximations, or with the aid of case distinctions, so that the mapping of the measured sensor values onto the data words or sensor signals of the communication bus are calculated automatically depending on the measured sensor value.

The calculation can then take place either in software on the sensor or through a logic within the sensor ASIC. A transmission of the sensor signals calculated from the measured sensor values then takes place over suitable communication means, for example on a communication slot according to the PSI5 protocol, or on a point-to-point connection.

The mapping function that is illustrated in FIG. 2 is symmetric, but the straight lines, curves or functions for mapping the measured sensor values onto data words can, of course, also be configured asymmetrically for the relevant regions. What is, however, crucial is that the more critical measuring ranges have a higher resolution than the less critical measuring ranges.

Whether a measuring range is deemed to be critical or less critical depends on the application that operates on the measured sensor values. Taking the example of a trigger algorithm as an application for the measured sensor values, the measured value ranges around the trigger thresholds are to be considered as critical. The resolution of the transmitted measured value is to be considered as rather less critical for measured value ranges for which no resolution clearly comes into question, or for which a resolution would clearly come into question.

FIG. 3 shows a mapping of data words or sensor signals onto measured sensor values after reception according to the present invention.

The sensor signals that are transferred to a communication bus according to the method for transmitting measured values are then, for example, received and processed at a control device such as an airbag control device.

In order that the sensor signals of the communication bus are correctly interpreted at the control device, a determination of the measured sensor value transmitted in the data word, including a conversion of the sensor signals of the communication bus, is performed according to the method for receiving measured values according to the present invention.

To this end, suitable determination rules are stored at the control device corresponding to the straight lines, curves or functions of a sensor type for mapping the measured values onto data words. Mathematical functions, for example. A mapping onto the value range of the control device thus takes place with the aid of the received sensor signals.

As is shown in FIG. 3, a straight line with a gradient again in the control device through an inverse mapping of the received data words or sensor signals. It is, however, noticeable, that the value range at the control device, with +/−600 LSB, is now significantly above the value range (+/−480 LSB) on the communication bus. Through the non-linear and variable resolution of the mapping of the sensor, it is thus possible in the context of the invention for a changed measuring range, increased in the illustrated example, to be transmitted on a communication bus.

The communication bus of the illustrated example is operated in accordance with the PSI5 protocol. This means that the data word has a length of 10 bits, and only has the possibility of transmitting +/−480 LSB.

Through the conversions at the sensor and control device end, +/−600 LSB is nevertheless created from this in this example. The resolution of the sensor signals above +200 LSB and below −200 LSB is, of course, rather worse than in the +/−200 LSB range. This, however, is intentional, since a high sensor resolution usually only has a high importance in the lower range (in this case +/−200 LSB). In the upper value range, a resolution in the range of single LSBs is usually no longer necessary.

FIG. 4 shows a flow diagram of a form of embodiment of a method for transmitting a measured value according to the present invention.

A measured value is acquired in step 401.

The acquired measured value is mapped onto a data word by means of a function in step 402. The function here describes the mapping of the measured value range onto the data word value range.

In step 403, the data word is transmitted over a communication means by means of a communication protocol. The PSI5 protocol here represents a preferred communication protocol. A communication bus or a point-to-point connection in accordance with the specifications of the PSI5 protocol is then a preferred communication means.

FIG. 5 shows a flow diagram of a form of embodiment of a method for receiving a measured value according to the present invention.

In step 501, a data word is received over a communication means by means of a communication protocol.

In step 502 the measured value that was transmitted with the data word is determined by means of a function.

1. A method for transmitting a measured value by a sensor, comprising:
mapping the measured value onto a data word according to a function in order to be transmitted.

2. The method as claimed in claim 1, wherein the mapping takes place in such a way that predetermined value ranges are mapped with a higher resolution.

3. The method as claimed in claim 1, wherein the function is a non-linear and/or non-symmetric and/or non-continuous function.

4. A sensor configured to map a measured value onto a data word according to at least one function and to transmit the measured value.

5. The sensor as claimed in claim 4, wherein the at least one function is stored in the sensor.

6. The sensor as claimed in claim 5, wherein, in an initialization phase, the sensor is configured to transmit the at least one function selected for the mapping.

7. The sensor as claimed in claim 4, wherein during manufacture of the sensor the at least one function is stored in the sensor.

8. The sensor as claimed in claim 4, wherein the measured value is determined from a received data word according to another function.

9. The sensor as claimed in claim 8, wherein:
in an initialization phase, the other function is received, and
the other function for determining the measured value depends on the received function.

10. The sensor as claimed in claim 4, wherein a control device is configured to carry out all steps of the method.

11. The method as claimed in claim 1, wherein a computer program is configured to carry out the method.

12. The method as claimed in claim 11, wherein the computer program is stored on a machine-readable storage medium.
